(19) United States
(12) Patent Application Publication
(10) Pub. No.: US 2020/0090490 A1
(43) Pub. Date: Mar. 19, 2020

(54) REMINDER DEVICE

(71) Applicant: Jae Yul KIM, Los Angeles, CA (US)

(72) Inventor: Jae Yul KIM, Los Angeles, CA (US)

(21) Appl. No.: 16/573,080

(22) Filed: Sep. 17, 2019

Related U.S. Application Data
(60) Provisional application No. 62/732,714, filed on Sep. 18, 2018.

(51) Int. Cl. G08B 21/24; G10L 15/26; G08B 3/00

(52) U.S. Cl. CPC G08B 21/24; G08B 3/00; G10L 15/265

(57) ABSTRACT

Disclosed herein is a reminder device that automatically transfers a necessary message to a user when entering or exiting a residence. The reminder device includes a body installed adjacent to a door, a sensor module disposed in the body to detect opening or closing of the door, a memory module disposed in the body to store a plurality of messages in form of data, an output module disposed outside the body to output a message stored in the memory module in form of at least one of speech and visual display, and a control module configured to receive a trigger signal including a detection signal of the sensor module and to selectively output at least one of messages stored in the memory module.

### BACKGROUND OF THE INVENTION

### Field of the Invention

The present invention relates to a reminder device, and more particularly, to a reminder device that automatically transfers a necessary message to a user when the user enters or exits a residence.

### Description of the Related Art

A wide variety of electronic and electrical devices which are used in our daily life are provided in home. In addition, a cooking device such as a gas stove, which receives combustible fuel through city gas piping, is also provided. When these devices are left unattended in the case of going out, these devices may cause unnecessary energy waste or safety accidents and therefore, it is necessary to inspect the devices.

In particular, windows and doors in the house need to be cracked when going out. But for most modern people who do not have time to spare with various activities, it is often difficult to perform these things perfectly. Therefore, an alternative to this is required, but technically appropriate alternatives have not yet been proposed. In particular, the elderly living alone or dementia patients have memory and cognitive ability that is not constant, and therefore, the prior art does not satisfy requirements to easily set a message and properly remind the situation.

For example, there is known a digital device (for example, Korean Patent Publication No. 10-2009-0009632) capable of notifying an individual of, via alarms, or recoding activity schedules of the individual on a daily or monthly basis, but the device merely lists records and therefore has a problem that it was difficult to notify the individual of information necessary for a situation or items to be necessarily remembered when the individual goes out or returns to home.

### SUMMARY OF THE INVENTION

The present invention has been made in an effort to solve such a problem, and to provide a reminder device that automatically transfers a necessary message to a user when entering or exiting a residence.

The technical problems of the present invention are not limited to the aforementioned problems, and any other technical problems not mentioned herein will be clearly understood from the following description by those skilled in the art.

According to an aspect of the present invention, a reminder device for outputting a message to a user when a door is opened or the user approaches the door includes a body installed adjacent to the door, a sensor module disposed in the body to detect opening or closing of the door, a memory module disposed in the body to store a plurality of messages in form of data, an output module disposed outside the body to output a message stored in the memory module in form of at least one of speech and visual display, and a control module configured to receive a trigger signal including a detection signal of the sensor module and to selectively output at least one of messages stored in the memory module.

The reminder device may further include a short range communication module disposed in the body and directly connected to an external terminal to enable data communication.

The trigger signal may further include an operation signal of the short range communication module, and the control module selectively outputs at least one of the messages according to the change of at least one of the detection signal and the operation signal.

The trigger signal may further include a beacon signal generated by detecting an external beacon by the short range communication module.

The beacon signal may be generated as different signals according to a plurality of different beacons and the control module outputs different messages according to the different beacon signals.

The reminder device may further include a network module disposed in the body and connected to an external terminal via network means including the Internet and an intranet.

The reminder device may further include an input module disposed outside the body to input a message in form of at least one of speech and text.

The control module may selectively output a message stored in the memory module to one of the output module and the external terminal.

The control module may automatically output the messages stored in the memory module in chronological order according to a preset time table.

### BRIEF DESCRIPTION OF THE DRAWINGS

FIG. 1 is a view showing an outer surface of a reminder device according to an embodiment of the present invention;

FIG. 2 is a block diagram illustrating a configuration of the reminder device of FIG. 1;

FIG. 3 is a conceptual diagram illustrating an arrangement and an operation method of the reminder device of FIG. 1; and

FIGS. 4 and 5 are views illustrating examples of the use of the reminder device of FIG. 1.

### DETAILED DESCRIPTION OF THE PREFERRED EMBODIMENTS

Advantages and features of the present invention and methods for achieving them will be apparent with reference to embodiments described below in detail in conjunction with the accompanying drawings. However, the present invention is not limited to the embodiments disclosed below but may be implemented in various forms. The present embodiments are merely provided to complete the disclosure of the present invention and to fully inform those skilled in the art of the scope of the invention, and the present invention is only defined by the claims. Like reference numerals refer to like elements throughout the specification.

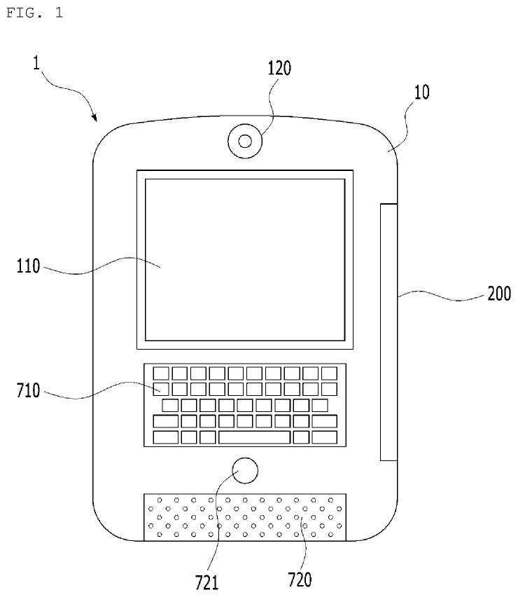

Hereinafter, a reminder device according to an embodiment of the present invention will be described in detail with reference to FIGS. 1 to 5.

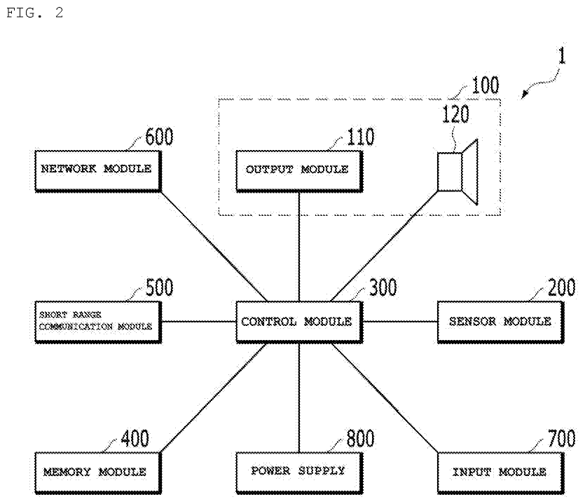

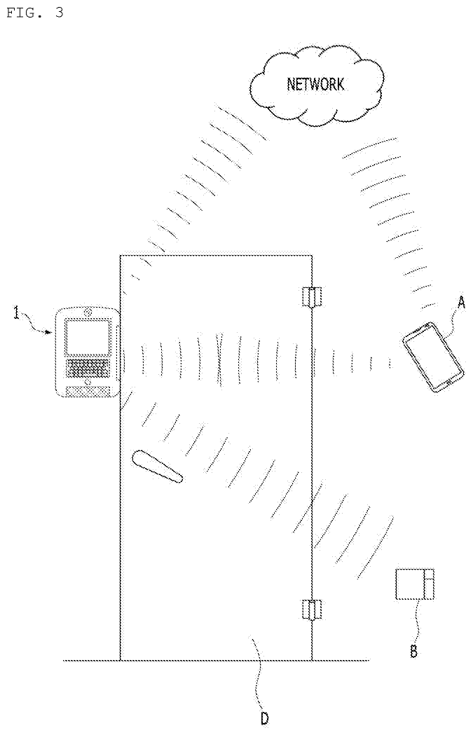

FIG. 1 is a view showing an outer surface of a reminder device according to an embodiment of the present invention, FIG. 2 is a block diagram illustrating a configuration of the reminder device of FIG. 1, and FIG. 3 is a conceptual diagram illustrating an arrangement and an operation method of the reminder device of FIG. 1.

Referring to FIGS. 1 to 3, a reminder device 1 of the present invention is installed adjacent to a door to operate (see D of FIG. 3). The reminder device 1 may detect opening or closing of the door and may output an appropriate message in response to the opening or closing state of the door. The message may be input to the reminder device 1 in advance, and the reminder device 1 may store a plurality of messages not a single message in the form of data and may selectively output one of the plurality of messages according to a situation. That is, the reminder device 1 may not simply list the stored messages but may output and transfer an appropriate message at the moment when an individual enters or exits the residence.

In particular, the reminder device 1 may be connected to an external terminal (see A of FIG. 3) owned by an individual user in a short range or long-distance communication method to transmit a necessary message to the external terminal. On the contrary, the individual user may access the reminder device 1 through the external terminal, and input or check a message or the like. In addition, the reminder device 1 may detect the connection operation with the external terminal and the opening/closing operation of the door as described above, and determine different situations, such as whether the individual is going out from the residence and whether the individual is returning to the residence after going out, and transfer an appropriate message to a user more accurately. By using an identifier capable of data communication such as a beacon, it is also possible to transfer a message to an individual having the beacon in a customized manner and induce the individual to perform an appropriate behavior.

The reminder device 1 of the present invention is configured as follows. The reminder device 1 includes a body 10 disposed adjacent to a front door, a sensor module 200 disposed in the body 10 to detect opening/closing of the door, a memory module 400 disposed in the body 10 to store a plurality of messages in the form of data, an output module 100 disposed outside the body 10 to output a message stored in the memory module 400 in at least one form of sound and visual display, and a control module 300 configured to receive a trigger signal including a detection signal of the sensor module 200 and selectively output at least one of the messages stored in the memory module 400.

According to one embodiment of the present invention, the reminder device 1 may further includes a short range communication module 500 disposed in the body 10 and directly connected to an external terminal to enable data communication. The trigger signal may further include an operation signal of the short range communication module 500. The control module 300 may selectively output at least one of the messages stored in the memory module 400 according to a change in at least one of the detection signal of the sensor module 200 and the operation signal. Further, the trigger signal may further include a beacon signal generated by the short range communication module 500 that detects an external beacon (see B of FIG. 3). The beacon signal may be generated as different signals corresponding to a plurality of different beacons. The control module 300 may generate different messages according to different beacon signals.

Hereinafter, the reminder device 1 of the present invention will be described in more detail with reference to an embodiment of the present invention. Other features of the present invention will be apparent from the following description.

Referring to FIGS. 1 and 2, the reminder device 1 may include the body 10 and various modules disposed in the body 10. The body 10 may function as a base for receiving and mounting the modules and determine a physical location of the reminder device 1. The body 10 may include, for example, a structure such as a housing in which an accommodation space is formed, to accommodate the modules inside the housing. As shown in FIG. 3, the body 10 may be installed adjacent to the front door (see D of FIG. 3), and thus, the opening and closing of the door may be more smoothly detected. The body 10 need not be limited to the illustrated shape and may be modified in various forms without particular limitation according to an overall shape, a structure, a size, and the like.

The sensor module 200 is disposed on the body 10 to detect the opening/closing of the door. The sensor module 200 may be at least partially exposed to the outside of the body 10 as shown in FIG. 2. The exposed portion may face the direction in which the door is located, thereby enabling the opening/closing state of the door to be more accurately detected. The sensor module 200 may include, for example, a proximity sensor that recognizes and detects an approach of an object and may include one or a plurality of different sensors to detect opening/closing of the door in different manners. The sensor module 200 may detect the movement of the door alone but may also be formed in such a way that a target or the like is installed on the side of the door and the movement of the target is recognized. The sensor module 200 may be implemented in various methods as long as it can detect the opening/closing of the door.

The reminder device 1 may include an input module 700 disposed outside the body 10 to input a message in the form of at least one of speech and text. The input module 700 may include a keyboard 710, a microphone module 720, and the like as shown in FIG. 1, and may be configured to allow the microphone module 720 to be easily manipulated by using a recording button 721. A message input through the input module 700 may have the form of at least one of a user's speech or text, and a message may be input in a combination thereof. In addition, the object capable of being input to the input module 700 may have the form of at least one of speech and text but need not be limited thereto. The object may include sound other than human speech, a visual symbol other than text, or a visual object (for example, a photograph, a picture, or the like). The input module 700 may also be modified in various forms to receive the user's message.

Meanwhile, the reminder device 1 may receive a message from an external terminal connected to the reminder device 1 to enable data communication in addition to the input module 700. As will be described later, the external terminal may receive a message output from the reminder device 1 so that the external terminal may function as a kind of a (relative) remote input/output device additionally connected. For example, when the external terminal is equipped with a recording function, a text input function, a display function, a photographing function, or the like, it is possible to input a message to the reminder device 1 and transfer the message output from the reminder device 1 through the external terminal by using all of the functions. The relationship between the reminder device 1 and the external terminal will be described in more detail later.

The memory module 400 is disposed in the body 10 and stores a plurality of messages in the form of data. The memory module 400 may include a semiconductor memory device and may increase a storage capacity when needed. The messages stored in the memory module 400 may be input from the above-described input module 700 or the external terminal, and a plurality of messages may be stored in the memory module 400. The messages stored in the memory module 400 may be deleted as necessary by accessing the control module 300 by operating the device using the input module 700. A new message may be input to the memory module 400 whenever necessary, and a message of which the expiration date has expired may be automatically deleted. In addition, it is also possible to set a message that should be repeatedly output without being deleted. A plurality of messages may be stored in the memory module 400 in various manners, and the stored messages may be managed.

The output module 100 is disposed outside the body 10 to output a message stored in the memory module 400 in the form of at least one of speech and visual display. The output module 100 may include a display module 110 or a speaker module 120 as shown in FIGS. 1 and 2. Various visual images such as text, symbols, photographs, and pictures may be output through the display module 110 and speech or sound may be output through the speaker module 120. The message may be output colorfully in a combination thereof. The output module 100 may be implemented in various forms in which a message may be transferred to a user, and the output module 100 need not be particularly limited thereto. For example, in a special case where it is difficult to transfer a message by speech or visual image, the output module 100 may transfer the message or assist the transfer of the message in another manner through another sense such as vibration.

On the other hand, as described above, the reminder device 1 may also transfer a message through an external terminal communicatively connected thereto. When the external terminal is equipped with a sound reproduction function, a display function, a vibration function, and the like, all of the functions may be used to receive a message from the reminder device 1. The external terminal may be, for example, a smartphone carried by an individual user and may receive a message from the reminder device 1 by using the functions provided in the smartphone. In addition, it is possible to search for, delete, add, or modify messages stored in the reminder device 1 while being connected to the reminder device 1 to enable data communication through an Internet connection function, Bluetooth, Wi-Fi function, or the like of the smartphone. For example, while the individual user is in the house, the user's external terminal may always be connected to the reminder device 1 in the manner such as Bluetooth and Wi-Fi, so that when the user suddenly thinks of something to do, the user may directly input a message to the reminder device 1, thereby being very effective for the elderly and demented patients who have poor memory.

The external terminal need not be limited to a smartphone, and it is also possible to implement the external terminal with any other device as long as it can be connected to the reminder device 1 to enable data communication.

The control module 300 may receive a trigger signal including a detection signal of the sensor module 200 and selectively output at least one of the messages stored in the memory module 400. The control module 300 may manage all the modules constituting the reminder device 1 including the memory module 400 and set or change the functions thereof. The control module 300 may include, for example, a central processing unit such as a CPU, and may be configured to perform data processing and calculations. Like a kind of a computer device, the control module 300 may be configured to perform a corresponding command when a user accesses the control module 300 and issues the command through the input module 700 described above or an external terminal communicatively connected. The control module 300 may control each module in various methods according to settings, and in particular, perform selective control according to the trigger signal in the control of selecting and outputting a message from the memory module 400. For example, the trigger signal may include a detection signal indicating the opening/closing of the door detected by the sensor module 200 described above, an operation signal of the short range communication module 500 described later, a beacon signal generated by detecting an external beacon, and the like. In addition, it is possible to perform control to output an appropriate message by considering the trigger signal. A variety of message transfer methods will be described in more detail later. Generally, the detection signal detected by the sensor module 200 may be a signal by a magnetic sensor. That is, the sensor module 200 installed in the body 10 may recognize a magnet installed in the door to determine whether the door is open or closed. Such a sensor module 200 may be configured in only one method but may be configured in a combination of various methods to increase accuracy. To generate the trigger signal, the above-described detection signal, the operation signal of the short range communication module 500, or the beacon signal may complement the technical limitations with each other, thereby increasing reliability when they are used together.

The reminder device 1 may include the short range communication module 500 directly connected to an external terminal to enable data communication. The short range communication module 500 may be disposed in the body 10 and may communicate data with the external terminal within a relatively limited range. The short range communication module 500 may be, for example, a Bluetooth module, but is not limited thereto, and may include other short range communication modules that use radio waves or communication standards or communication methods in other wavelength bands. The reminder device 1 may be directly connected to the external terminal of the user through the short range communication module 500 within a communicable range, and may receive a message from the reminder device 1 in such a state. However, even when the external terminal is communicatively connected to the reminder device 1, the message does not need to be necessarily transferred only through the external terminal, and the message is received through both the reminder device 1 and the external terminal, or the settings of the reminder device 1 or an external terminal may be changed to receive the message by selecting either the reminder device 1 or an external terminal.

In addition, the reminder device 1 may include a network module 600 disposed in the body 10 and connected to the external terminal via network means including the Internet and an Intranet. The network module 600 may maintain the connection state between the external terminal and the reminder device 1 even when being out of the communicable range of the short range communication module 500. The network module 600 may be connected to the network means such as the Internet or the Intranet in a wired or wireless manner, and the external terminal may maintain a communication state with the reminder device 1 by connecting to and passing through the network means. Switching from a connection state through the short range communication module 500 to a connection state through the network module 600 may be automatically performed according to the movement of the user, for example, and may be manually performed through a change in the settings of the reminder device 1 or the external terminal. The network module 600 may include, for example, a communication device such as a modem and a peripheral device connected to the Internet network or an intranet network in a wired or wireless manner.

The reminder device 1 may include a power supply 800 that enables the operations of these modules. The power supply 800 may be disposed inside the body 10 and may include a battery, a power converting device, or the like. The power supply 800 may be formed to receive power from the battery or may also be formed to receive power from a power supply source in the home as needed. The power supply 800 may receive power in many different manners and supply the power to the modules to operate without problems. For example, when the battery is used, the amount of remaining power may be notified to the user through the output module 100 or the like.

A diagram of the arrangement and operation of the reminder device 1 is shown in FIG. 3. Referring to FIG. 3, the reminder device 1 is installed adjacent to a door D to detect opening/closing of the door D, and outputs an appropriate message accordingly. In this case, the output message is selected from a plurality of messages stored in the memory module 400. The message may be selected in various ways as follows. For example, the control module 300 may control the memory module 400 and the output module 100 such that the latest message input most recently in time is outputted. That is, it is possible to transfer, to a user, a message input by the user before going out the day before by outputting the message to the user when going out. In this case, it may be used for one member of a family to transfer a necessary message to another member. In addition, the control module 300 may automatically output the messages stored in the memory module 400 in chronological order according to a preset timetable. For example, it is possible to stores a plurality of messages according to a relatively long-term schedule on a yearly or monthly basis and, when a corresponding date arrives, perform control to output a related message to the user when the door D is opened according to the date. When the opening/closing of the door D is detected, one or more of these messages may be sequentially output. Therefore, it is possible to transfer, to the user, a message having a predetermined date to be played back according to the timetable, and a relatively urgently input latest message together.

In addition, the memory module 400 of the reminder device 1 may also store essential messages that are always output whenever the door D is opened or closed. For example, whether or not to close the entrance of a house, various electric and electronic devices, a heating device, a confirmation message of an inspection status associated with a cooking utensil may be controlled to be essentially output. Basically, a method of outputting the messages may be set in advance by the user by operating the reminder device 1, the settings thereof may be changed at any time, and invalid message may be deleted. The control module 300 may perform various controls such that an appropriate message is output according to various settings of the user. The message transfer method is merely an example, and the control method may be changed such that the message is output in various other ways. In addition, the control module 300 may selectively output the message stored in the memory module 400 to any one of the output modules 100 and the external terminal A, as described above. Therefore, when the user is unexpectedly located outside the residence, the user may receive with the message as scheduled.

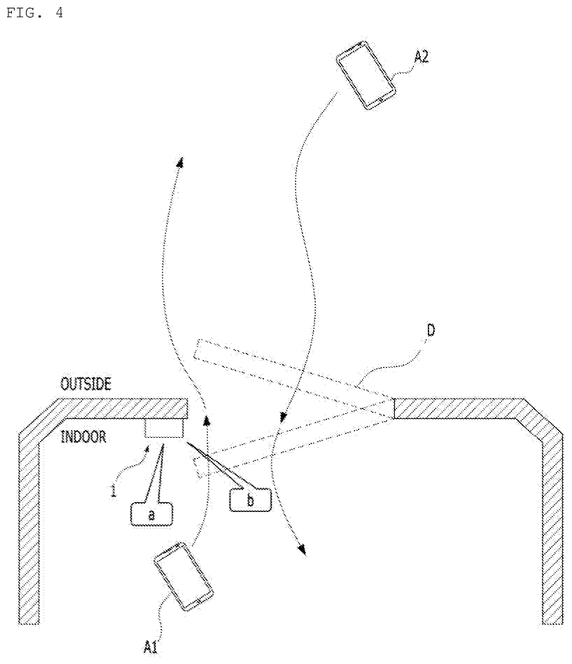

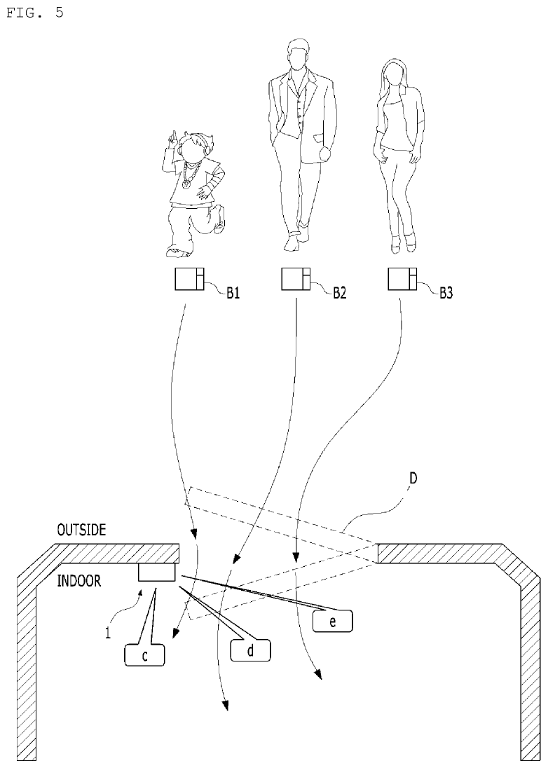

Meanwhile, as shown in FIG. 3, the reminder device 1 may transfer a message more precisely in association with the external terminal A, the beacon B, and the like. As described above, the external terminal A may be directly connected to the reminder device 1 through the above-mentioned short range communication module 500, or may be connected to the reminder device 1 through network means such as the Internet or Intranet via the network module 600 when the distance between the external terminal A and the reminder device 1 increases. The beacon B is capable of data communication in, for example, a Bluetooth method and is connected to the short range communication module 500 to perform data communication. Therefore, the reminder device 1 may provide the control module 300 with the operation signal of the short range communication module 500 and the beacon signal generated by detecting the external beacon B by the short range communication module 500 in addition to the detection signal for opening and closing of the door D detected by the sensor module 200, as the trigger signals, in a combination thereof, to allow a message of more suitable content to be transferred to the user. Hereinafter, details will be given with reference to FIGS. 4 and 5.

FIGS. 4 and 5 are views illustrating examples of the use of the reminder device of FIG. 1.

First, as shown in FIG. 4, the reminder device 1 may determine whether the user goes out or returns to home based on the open state of the door D and the connection state between the external terminal A1 or A2 and transfer a corresponding message to the user. For example, when the user opens the door D in the house and goes out of the house while being connected to the external terminal A1 through the short range communication module 500 described above, the control module 300 described above may recognize the detection signal of the sensor module 200 according to the opening of the door D and the operation signal of the short range communication module 500 and determine that the user goes out the house. In this case, the operation signal of the short range communication module 500 may refer to a communication strength between the short range communication module 500 and the external terminal A1, which may be detected by the short range communication module 500 itself that searches for radio waves continuously to maintain the connection state. That is, when the door D is opened and the detection signal is transmitted in a state in which the external terminal A1 maintains a communication strength of a certain strength or more in the house and is stably connected to the reminder device 1, the control module 300 may determine that the user goes out and perform control to output an appropriate message a. In such a case, whether or not the entrance of the house is closed, a confirmation message of the inspection state associated with various electric and electronic devices, a heating device or a cooking utensil, or the like may be transferred to the user more effectively to achieve the purpose.

On the other hand, when the user returns to the house, the communication strength greatly changes in a short time between the short range communication module 500 of the reminder device 1 and the external terminal A2. That is, in a state where there is no direct data communication between the reminder device 1 and the external terminal A2 outside a range in which the short range communication is possible, as the reminder device 1 approaches the external terminal A2, the short range communication module 500 is directly connected to the external terminal A2, leading to a dramatic increase in the communication strength. In this case, when the door D is opened and the detection signal is transmitted, the control module 300 may determine that the user returns to the house and perform control to output another message b corresponding thereto. In this case, for example, it is possible to guide an external inspection rather than a situation inside the house or notify the user of a task to be performed immediately after entering the house through a message. That is, for example, by using the above-described detection signal and the operation signal as a complex trigger signal, the control module 300 may perform control to more precisely output a message suitable for a situation.

Also, as shown in FIG. 5, the reminder device 1 may output different messages according to different beacon signals generated corresponding to different beacons B1, B2, and B3. In this case, the beacon signals may be obtained by the above-mentioned short range communication module 500 while the short range communication module 500 is communicating data with each of the beacons B1, B2, and B3. Each beacon B1, B2, or B3 records different data therefor. The beacons B1, B2, and B3 may be carried by different users, for example, in the form of chips. In this case, each of the beacons B1, B2, and B3 functions as an indicator for recognizing different users. Thus, for example, when a child carries the beacon B1 and opens the door D in proximity to the reminder device 1, the control module 300 may be controlled to output a customized message related to the child according to the detection signal. In addition, when other users respectively carry different beacons B2 and B3 and open the door D, the control module 300 may be controlled to output other customized messages respectively suitable for the users according to a detection signal. Such customized messages may be distinguished by specifying the beacons B1, B2, and B3 or the users in the reminder device 1, for example. In this way, by using the detection signal and the beacon signal described above as a complex trigger signal, the control module 300 may perform control to more precisely output a message suitable for a situation.

In addition, the reminder device 1 may be set for each situation and for each time zone. For example, during a period for which a heating device or a cooling device is driven in the house, such as winter or summer, a message related to the turning-on or -off of the heating device or the cooling device may be transferred to a user. When the user takes exercise at dawn, a message related to a towel or a bucket may be transferred to the user. When the user goes out after a meal, a message related to a cooking utensil, such as a gas range may be transferred to the user.

In addition, it is possible to obtain information from various sensors installed inside and outside the house and output a preset message. For example, when the temperature of the house is high when the user goes out, a message related to a heating device may be transferred to the user and when the illumination of the house is high, a message relate to a lamp may be transferred to the user.

Data on such external conditions may be obtained not only through various sensors but also through a network. For example, when weather information is received, a message related to an umbrella or a dress may be transferred to the user, or when crime information or a variety of danger information is received, warning information may be transferred to the user.

The methods of outputting or transferring such a message may be used in any combination with each other and may be modified by changing settings or changed to another type, and thus, the reminder device 1 of the present invention may be effectively used in various ways based on the above description.

According to the present invention, it is possible to be conveniently notified of various checks or necessary matters, items not to be forgotten, or the like, when a user enters or exits the residence. In particular, when a space of living is changed, such as when the user goes out home or when the user returns to home, it is possible to transfer items to be checked or matters to be checked to an individual user to induce the individual user to perform appropriate activities. In addition, it is possible to share and transfer necessary messages among family members to promote friendships and strengthen bonds, and to transfer a list such as important work schedules of the individual user from time to time to make the user's daily life more convenient and efficient.

Although embodiments of the present invention have been described above with reference to the accompanying drawings, it is understood that those skilled in the art to which the present invention pertains may implement the present invention in other specific forms without changing the technical spirit or essential features thereof. Therefore, it should be understood that the embodiments described above are exemplary in all respects and not restrictive.

What is claimed is:

1. A reminder device for outputting a message to a user when a door is opened or the user approaches the door, the reminder device comprising:
a body installed adjacent to the door;
a sensor module disposed in the body to detect opening or closing of the door;
a memory module disposed in the body to store a plurality of messages in form of data;
an output module disposed outside the body to output a message stored in the memory module in form of at least one of speech and visual display; and
a control module configured to receive a trigger signal including a detection signal of the sensor module and to selectively output at least one of messages stored in the memory module.

2. The reminder device of claim 1, further comprising:
a short range communication module disposed in the body and directly connected to an external terminal to enable data communication.

3. The reminder device of claim 2, wherein the trigger signal further includes an operation signal of the short range communication module, and the control module selectively outputs at least one of the messages according to the change of at least one of the detection signal and the operation signal.

4. The reminder device of claim 2, wherein the trigger signal further includes a beacon signal generated by detecting an external beacon by the short range communication module.

5. The reminder device of claim 4, wherein the beacon signal is generated as different signals according to a plurality of different beacons and the control module outputs different messages according to the different beacon signals.

6. The reminder device of claim 1, further comprising:
a network module disposed in the body and connected to an external terminal via network means including the Internet and an intranet.

7. The reminder device of claim 1, further comprising:
an input module disposed outside the body to input a message in form of at least one of speech and text.

8. The reminder device of claim 2 or 6, wherein the control module selectively outputs a message stored in the memory module to one of the output module and the external terminal.

9. The reminder device of claim 1, wherein the control module automatically outputs the messages stored in the memory module in chronological order according to a preset timetable.
